(19) United States
(12) Patent Application Publication
(10) Pub. No.: US 2026/0056780 A1
(43) Pub. Date: Feb. 26, 2026

(54) DATA PROCESSING SYSTEM AND DATA PROCESSING METHOD

(71) Applicant: Semiconductor Energy Laboratory Co., Ltd., Atsugi-shi (JP)

(72) Inventors: Naoaki TSUTSUI, Atsugi (JP); Ryo NAKAZATO, Ebina (JP)

(21) Appl. No.: 19/235,852

(22) Filed: Jun. 12, 2025

(30) Foreign Application Priority Data
Jul. 5, 2024 (JP) 2024-108622

(51) Int. Cl. G06F 9/48; G06F 18/2415

(52) U.S. Cl. CPC G06F 9/4881; G06F 18/2415

(57) ABSTRACT

A novel data processing system that is highly convenient, useful, or reliable is provided. The data processing system includes three components. A first component receives a job script, transmits the job script to a third component, and provides a determination result. A second component receives a first prompt, performs processing using a large language model, and extracts first setting information. The third component receives the job script and the first setting information, shares the job script and the first setting information in the third component, and transmits a determination result to the first component. The third component includes a first subcomponent and a second subcomponent. The first subcomponent creates the first prompt and transmits the first prompt to the second component. The second subcomponent performs processing using a classifier and determines whether the first setting information includes an inappropriate setting.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a data processing device, a semiconductor device, a storage device, a method for driving any of them, and a method for manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, an interactive model that gives an answer to a user's instruction can be achieved. In Non-Patent Document 1, generative pre-trained transformer 4 (GPT-4, registered trademark) is disclosed as a large language model, and ChatGPT is disclosed as an interactive model.

By utilizing a large language model, the capacity of a natural language processing model is significantly increased. On the other hand, it is difficult to incorporate and operate a language model at one's own facilities and expense due to the expansion of the language model. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. In one embodiment of the present invention, there is no need to achieve all of these objects. Other objects will be apparent from and can be derived from the description of the specification, the drawings, the claims, and the like.
(1) One embodiment of the present invention is a data processing system including a first component, a second component, and a third component.

The first component has a function of receiving a job script, transmitting the job script to the third component, receiving a determination result, and providing the determination result. Note that the job script includes first setting information.

The second component has a function of receiving a first prompt, transmitting the first setting information to the third component, and performing processing using a large language model. Note that the large language model has a function of extracting the first setting information from the job script in accordance with the first prompt.

The third component has a function of receiving the job script and the first setting information, sharing the job script and the first setting information in the third component, and transmitting the determination result to the first component. The third component includes a first subcomponent and a second subcomponent.

The first subcomponent has a function of creating the first prompt and transmitting the first prompt to the second component. The first prompt includes the job script and a first instruction, and the first instruction includes an instruction for extracting the first setting information from the job script.

The second subcomponent has a function of performing processing using a classifier. The classifier has a function of determining whether the first setting information includes an inappropriate setting and outputting the determination result.

Thus, for example, it is possible to determine whether the inappropriate setting is included in the job script input to a supercomputer. For another example, it is possible to determine whether a setting that unreasonably occupies a calculational resource prepared for parallel processing is included in the job script. For another example, when a setting of a calculation end time is not included in the first setting information, it is possible to determine that the job script includes the inappropriate setting. For another example, the user of the data processing system can be provided with the determination result. For another example, the user of the data processing system can review the job script. As a result, a novel data processing system that is highly convenient, useful, or reliable can be provided.
(2) Another embodiment of the present invention is the data processing system in which the second component has a function of receiving a second prompt. Note that the large language model has a function of converting the first setting information into second setting information in accordance with the second prompt.

The third component has a function of receiving the second setting information and sharing the second setting information in the third component.

The first subcomponent has a function of creating the second prompt and transmitting the second prompt to the second component. The second prompt includes the first setting information, a conversion rule, and a second instruction, and the conversion rule includes a fixed expression. The second instruction includes an instruction for converting the first setting information into the second setting information by referring to the conversion rule and adjusting an expression of the first setting information to the fixed expression.

The second subcomponent has a function of performing processing using a simple Bayesian model. The simple Bayesian model has a function of estimating probability that the second setting information includes an inappropriate setting. The classifier uses an estimation result of the simple Bayesian model to determine whether the first setting information includes the inappropriate setting.

Thus, the same or similar expressions used in the first setting information can be consolidated in the fixed expression. For example, in the case where the first setting information includes a fluctuation in expressions, the expressions can be converted into any of the fixed expressions. In addition, probability P(A|B) that the second setting information including one fixed expression is inappropriate can be found using the simple Bayesian model. For another example, probability P(B|A) that the inappropriate setting includes the fixed expression, probability P(A) that the job script including the inappropriate setting is input, and probability P(B) that the job script that is input includes the fixed expression can be used for training data. Furthermore, the probability P(A|B) can be predicted from the value obtained by dividing the product of the probability P(B|A) and the probability P(A) by the probability P(B). Moreover, it is possible to accurately determine whether the first setting information includes the inappropriate setting using the probability P(A|B). For example, the user of the data processing system can be provided with the determination result. For another example, the user of the data processing system can review the job script. As a result, a novel data processing system that is highly convenient, useful, or reliable can be provided.
(3) Another embodiment of the present invention is the data processing system in which the third component includes a third subcomponent. Note that the third subcomponent has a function of calculating an elapsed time since input of the job script and adding the elapsed time to the second setting information.

Thus, it is possible to determine whether the inappropriate setting is included in the job script that has been input to the supercomputer on the basis of the elapsed time, for example. Furthermore, on the basis of the elapsed time, the user of the data processing system can be prompted to review the job script, for example. For another example, the user of the data processing system can be provided with the determination result. For another example, the user of the data processing system can review the job script. As a result, a novel data processing system that is highly convenient, useful, or reliable can be provided.
(4) Another embodiment of the present invention is the data processing system including a fourth component.

The fourth component has a function of receiving the job script, transmitting a calculation result to the third component, receiving a priority change command, and changing a priority of the job script. Note that the calculation result is a result of executing the job script.

The third component has a function of transmitting the job script to the fourth component, transmitting the priority change command to the fourth component in the case where the first setting information is determined to include the inappropriate setting, and receiving the calculation result and transmitting the calculation result to the first component.

The first component has a function of receiving the calculation result and providing the calculation result.

Thus, when the execution of the job script is completed, the user of the data processing system can be provided with the calculation result for example. When the job script has a high possibility of including the inappropriate setting, the priority change command can be transmitted to the fourth component. In addition, the execution of the job script including the inappropriate setting can be delayed using the priority change command. As a result, a novel data processing system that is highly convenient, useful, or reliable can be provided.
(5) Another embodiment of the present invention is a data processing method including a first step, a second step, a third step, a fourth step, a fifth step, a sixth step, a seventh step, an eighth step, a ninth step, a tenth step, an eleventh step, a twelfth step, a thirteenth step, a fourteenth step, and a fifteenth step.

In the first step, a first component receives a job script and transmits the job script to a second component.

In the second step, the second component receives the job script and shares the job script in the second component. Note that the job script includes first setting information. The second component includes a first subcomponent and a second subcomponent.

In the third step, the first subcomponent creates a first prompt and transmits the first prompt to a third component. Note that the first prompt includes the job script and a first instruction. The first instruction includes an instruction for extracting the first setting information from the job script.

In the fourth step, the third component receives the first prompt and extracts the first setting information using a large language model.

In the fifth step, the third component transmits the first setting information to the second component.

In the sixth step, the second component receives the first setting information and shares the first setting information in the second component.

In the seventh step, the first subcomponent creates a second prompt and transmits the second prompt to the third component. Note that the second prompt includes the first setting information and a second instruction. The second instruction includes an instruction for converting the first setting information into second setting information by adjusting an expression of the first setting information to a fixed expression.

In the eighth step, the third component receives the second prompt and converts the first setting information into the second setting information using the large language model.

In the ninth step, the third component transmits the second setting information to the second component.

In the tenth step, the second component receives the second setting information and shares the second setting information in the second component.

In the eleventh step, the second subcomponent estimates probability that the second setting information includes an inappropriate setting using a simple Bayesian model.

In the twelfth step, a classifier determines whether the first setting information includes an inappropriate setting using an estimation result of the second setting information of the simple Bayesian model and outputs a determination result.

In the thirteenth step, the second component transmits the determination result to the first component.

In the fourteenth step, the second component calculates an elapsed time since input of the job script at a predetermined time, and the elapsed time is added to the second setting information and shared in the second component.

In the fifteenth step, processing ends in the case where the job script is finished, and the processing proceeds to the eleventh step in the case where the job script is not finished.

Thus, the same or similar expressions used in the first setting information can be consolidated in the fixed expression. For example, in the case where the first setting information includes a fluctuation in expressions, the expressions can be converted into any of the fixed expressions. The probability P(A|B) that the second setting information including one fixed expression is inappropriate can be found using the simple Bayesian model. For another example, the probability P(B|A) that the inappropriate setting includes the fixed expression, the probability P(A) that the job script including the inappropriate setting is input, and the probability P(B) that the job script that is input includes the fixed expression can be used for the training data. The probability P(A|B) can be predicted from the value obtained by dividing the product of the probability P(B|A) and the probability P(A) by the probability P(B). It is possible to accurately determine whether the first setting information includes the inappropriate setting using the probability P(A|B). In addition, it is possible to determine whether the inappropriate setting is included in the job script that has been input the supercomputer on the basis of the elapsed time, for example. On the basis of the elapsed time, the user of the data processing system can be prompted to review the job script, for example. For another example, the user of the data processing system can be provided with the determination result. For another example, the user of the data processing system can review the job script. As a result, a novel data processing method that is highly convenient, useful, or reliable can be provided.
(6) Another embodiment of the present invention is the data processing method, and in the second step, the second component receives the job script and transmits the job script to a fourth component.

Note that the fourth component has a function of receiving the job script, transmitting a calculation result to the second component, receiving a priority change command, and changing a priority of the job script.

In the case where the first setting information is determined to include the inappropriate setting, the second component transmits the priority change command to the fourth component in the thirteenth step.

Thus, when the job script has a high possibility of including the inappropriate setting, the priority change command can be transmitted to the fourth component. In addition, the execution of the job script including the inappropriate setting can be delayed using the priority change command. As a result, a novel data processing method that is highly convenient, useful, or reliable can be provided.

One embodiment of the present invention can provide a novel data processing system that is highly convenient, useful, or reliable. Alternatively, a novel data processing method that is highly convenient, useful, or reliable can be provided. Alternatively, a novel data processing system, a novel data processing method, or a novel semiconductor device can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of a data processing system of an embodiment;

FIGS. 2A and 2B illustrate a structure of setting information and a structure of a job script of an embodiment;

FIGS. 3A and 3B illustrate a structure of a component used in a data processing system of an embodiment;

FIGS. 4A and 4B each illustrate a structure of a prompt of an embodiment;

FIGS. 5A and 5B illustrate a structure of a component used in a data processing system of an embodiment;

FIG. 6 illustrates a structure of a data processing device used for a data processing system of an embodiment;

FIG. 7 illustrates a data processing method of an embodiment; and

FIG. 8 illustrates a data processing method of an embodiment.

### DETAILED DESCRIPTION OF THE INVENTION

The data processing system of one embodiment of the present invention includes a first component, a second component, and a third component. The first component has a function of receiving a job script, transmitting the job script to the third component, receiving a determination result, and providing the determination result. Note that the job script includes first setting information. The second component has a function of receiving a first prompt, transmitting the first setting information to the third component, and performing processing using a large language model. The large language model has a function of extracting the first setting information from the job script in accordance with the first prompt. The third component has a function of receiving the job script and the first setting information, sharing the job script and the first setting information in the third component, and transmitting the determination result to the first component. The third component includes a first subcomponent and a second subcomponent. The first subcomponent has a function of creating the first prompt and transmitting the first prompt to the second component. Note that the first prompt includes the job script and a first instruction, and the first instruction includes an instruction for extracting the first setting information from the job script. The second subcomponent has a function of performing processing using a classifier, and the classifier has a function of determining whether the first setting information includes an inappropriate setting and outputting the determination result.

Thus, for example, it is possible to determine whether the inappropriate setting is included in the job script input to a supercomputer. For another example, it is possible to determine whether a setting that unreasonably occupies a calculational resource prepared for parallel processing is included in the job script. For another example, when a setting of a calculation end time is not included in the first setting information, it is possible to determine that the job script includes the inappropriate setting. For another example, the user of the data processing system can be provided with the determination result. For another example, the user of the data processing system can review the job script. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components. Thus, the terms do not limit the number of components or the order of components (e.g., the order of steps or the stacking order of layers). A term without an ordinal number in this specification and the like might be provided with an ordinal number in a claim in order to avoid confusion among components. A term with an ordinal number in this specification and the like might be provided with a different ordinal number in a claim. A term with an ordinal number in this specification and the like might not be provided with an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

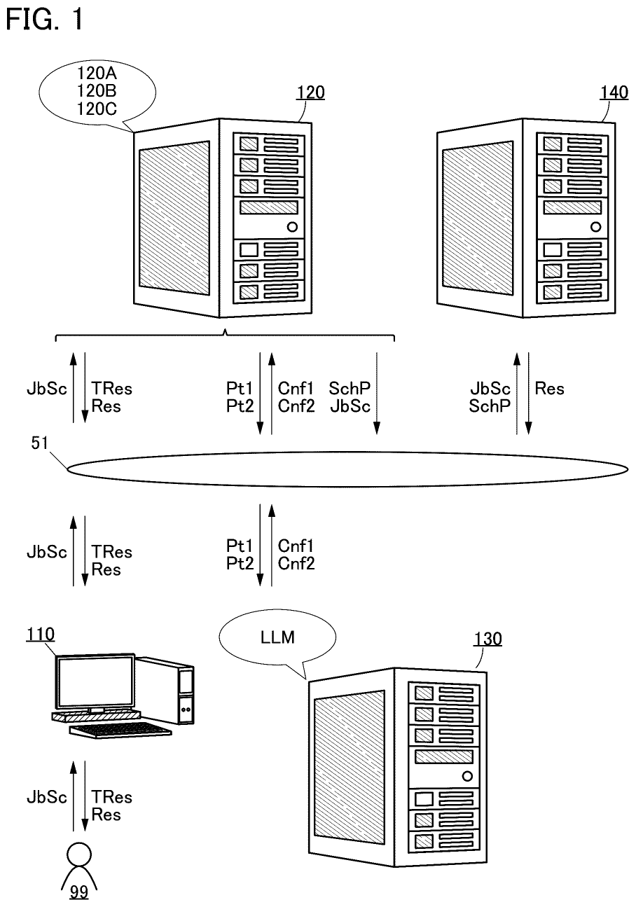

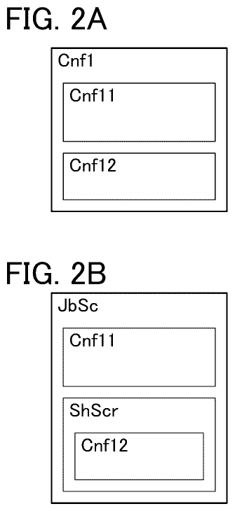

In this embodiment, a data processing system of one embodiment of the present invention will be described with reference to FIG. 1, FIGS. 2A and 2B, FIGS. 3A and 3B, FIGS. 4A and 4B, FIGS. 5A and 5B, and FIG. 6.

FIG. 1 illustrates a structure of the data processing system of one embodiment of the present invention.

FIG. 2A illustrates a structure of a job script used for the data processing system of one embodiment of the present invention, and FIG. 2B illustrates a structure of setting information extracted from the job script.

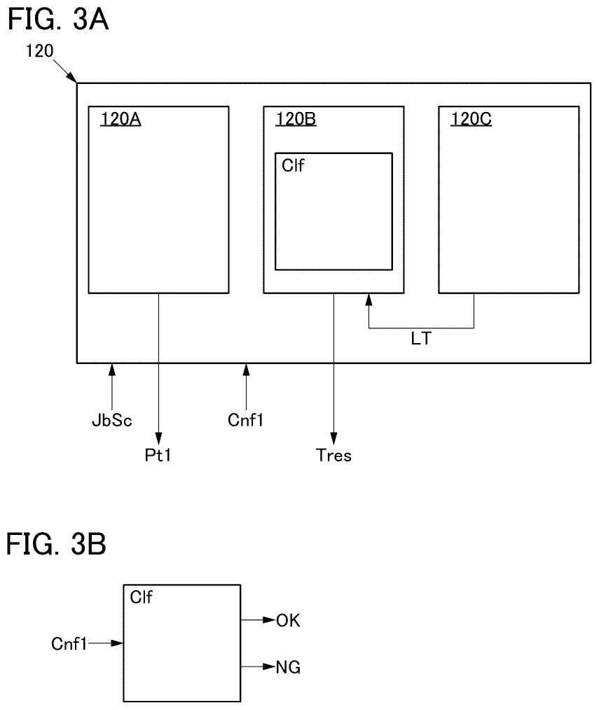

FIG. 3A illustrates a structure of a component used for the data processing system of an embodiment, and FIG. 3B illustrates part of the component.

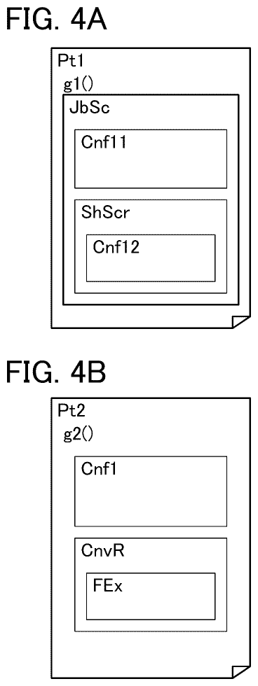

FIGS. 4A and 4B each illustrate a structure of a prompt that is transmitted and received in the data processing system of one embodiment of the present invention.

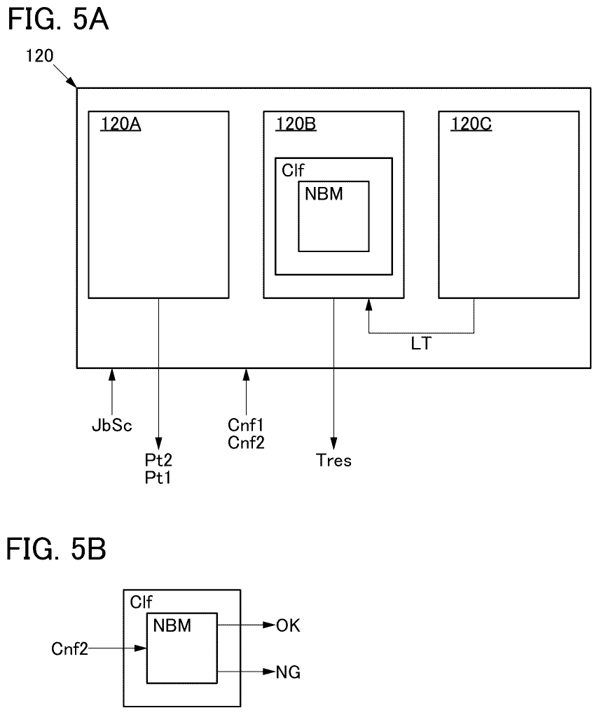

FIG. 5A illustrates a structure of a component used for the data processing system of an embodiment, and FIG. 5B illustrates part of the component.

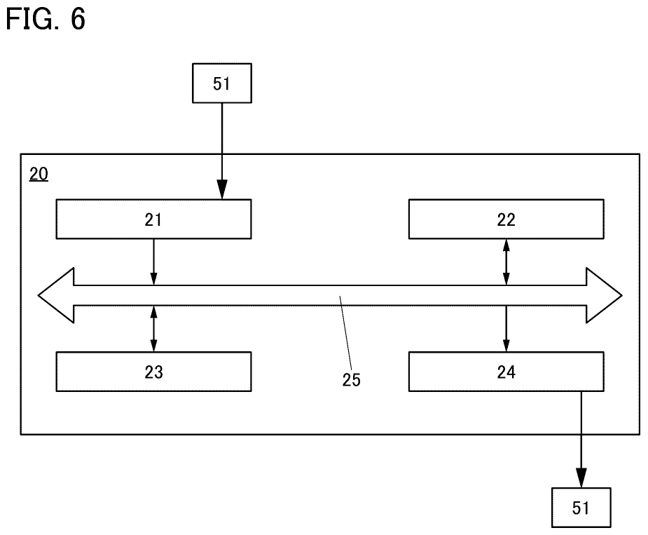

FIG. 6 is a block diagram illustrating a structure of a data processing device which can be used for the data processing system of one embodiment of the present invention.

### Structure Example 1 of Data Processing System

The data processing system described in this embodiment includes a component 110, a component 130, and a component 120 (see FIG. 1). Note that the data processing device having a function of the component 110, a data processing device having a function of the component 130, and a data processing device having a function of the component 120 each include an arithmetic device and a communication device. Furthermore, for example, these data processing devices are connected to each other using a network 51.

### Structure Example 1 of Component 110

The component 110 has a function of receiving a job script JbSc and transmitting the job script JbSc to the component 120. For example, a user 99 of the data processing system inputs the job script JbSc to the component 110. Specifically, the user of the data processing system inputs the job script JbSc to the component 110 with use of an input device such as a keyboard, a mouse, an eye-gaze input device, or a microphone.

The component 110 has a function of receiving a determination result TRes from the component 120 and providing the user of the data processing system with the determination result TRes, for example.

### Structure Example of Job Script JbSc

The job script JbSc includes setting information Cnf1. Note that the setting information Cnf1 includes one or more pieces of setting information. For example, the setting information Cnf1 can be formed with setting information Cnf11 and setting information Cnf12 (see FIG. 2A).

The user of the data processing system has discretion over the way of writing the job script JbSc, and the setting information Cnf1 can be written in the job script JbSc in various ways. For example, the setting information Cnf11 and a shell script ShScr can be written, and the setting information Cnf12 can be written in the shell script ShScr (see FIG. 2B).

### Structure Example of Setting Information Cnf1

The setting information Cnf1 includes one or more pieces of information that pairs an item (also referred to as a key) and a value corresponding to each item. For example, the name of a job, the name of a queue of an input destination, an input/output destination of data, the maximum processing time, the size of a configured usage resource, the size of a usage resource interpreted from a script unit, or the like can be used as the item. Note that the size of the usage resource includes the number of computing nodes to be used, the number of central processing units (CPUs) to be used, the capacity of memories to be used, the number of graphics processing units (GPUs) to be used, and the like.

### Structure Example 1 of Component 130

The component 130 has a function of receiving a prompt Pt1 and transmitting the setting information Cnf1 to the component 120. In addition, the component 130 has a function of performing processing using a large language model LLM.

### Structure Example 1 of Large Language Model LLM

The large language model LLM has a function of extracting the setting information Cnf1 from the job script JbSc in accordance with the prompt Pt1. As described above, since the user of the data processing system has discretion over the way of writing the job script JbSc, the setting information Cnf1 is also written in the job script JbSc in various ways. As a result, in a complicated case, classification is necessary and performing extraction through programming is difficult. Meanwhile, the large language model LLM can be suitably used for a task that extracts the setting information Cnf1 from the job script JbSc.

For example, the setting information Cnf1 can be extracted from the job script JbSc using a large language model such as GPT-3 (registered trademark), GPT-3.5, GPT-4 (registered trademark), LaMDA, Llama2, or Llama3.

### Structure Example 1 of Component 120

The component 120 has a function of receiving the job script JbSc and the setting information Cnf1, and sharing the job script JbSc and the setting information Cnf1 in the component 120.

The component 120 has a function of transmitting the determination result TRes to the component 110.

Note that the component 120 includes a subcomponent 120A and a subcomponent 120B (see FIG. 3A). In this specification, a structure having a single function or a plurality of functions is referred to as a component or a subcomponent for convenience of description.

### Structure Example 1 of Subcomponent 120A

The subcomponent 120A has a function of creating the prompt Pt1 and transmitting the prompt Pt1 to the component 130.

### Structure Example of Prompt Pt1

The prompt Pt1 includes the job script JbSc and an instruction g1( ) (see FIG. 4A). The instruction g1( ) includes an instruction for extracting the setting information Cnf1 from the job script JbSc.

For example, a text in the next paragraph can be used as the prompt Pt1. Like the setting information, a JavaScript Object Notation (abbreviation: JSON) format is suitable for management of information that pairs the item and the value. The JSON format is suitable for the output format of the large language model LLM.

“Analyze input script and extract information on job such as number of CPU, memory, and GPU that are used. Output extracted setting information in JSON format.
(Input 1)
#!/bin/sh
#JOB-q small
#JOB-l nodes=1:ncpus=2:ngpus=1:mem=40g
#JOB-N CAD_LLM3-8B
#JOB-j oe
./program01.exe--cpus 8--gpus 4
(Output 1)
{
   “job-name”: “CAD_LLM33-8B”,
   “queue”: “small”,
   “job-cpu”: 2,
   “job-gpu”: 1,
   “job-mem”: 40,
   “real-cpu”: 8,
   “real-gpu”: 4,
}
(Input 2)
#!/bin/sh
#JOB-q large
#JOB-l nodes=1:ncpus=4:ngpus=3:mem=80g
#JOB-N CAD_LLM3-8B
#JOB-j oe
sing-ai_202405 python3-u run_llm.py ¥
   r 192.168.214.107-p 60537 ¥
   m LLM3-8B ¥
   --gpus=2 ¥
   f LLM3-8B.gguf
(Output 2)
{
   “job-name”: “CAD_LLM3-8B”,
   “queue”: “large”,
   “job-cpu”: 4,
   “job-gpu”: 3,
   “job-mem”: 80,
   “real-cpu”: 1,
   “real-gpu”: 2,
}
(Input 3)
#!/bin/sh
#JOB-q large
#JOB-l nodes=1:ncpus=1:ngpus=4:mem=80g
#JOB-N CAD_LLM3-8B
#JOB-j oe
sing-ai_202405 python3-u run_llm.py ¥
   r 192.168.214.107-p 60537 ¥
   m LLM3-8B ¥
   --gpus=8 ¥
   f CAD_LLM3-8B.gguf
(Output 3)”

Note that “Analyze input script and extract information on job such as number of CPU, memory, and GPU that are used. Output extracted setting information in JSON format.” described above corresponds to the instruction g1( ). “(Input 1)”, “(Input 2)”, and “(Input 3)” are headings, and a portion following each of the headings corresponds to the job script JbSc. “(Output 1)”, “(Output 2)”, and “(Output 3)” are also headings. In a portion following the heading “(Output 1)”, setting information extracted from the job script JbSc following “(Input 1)” is shown as an example. In a portion following the heading “(Output 2)”, setting information extracted from the job script JbSc following “(Input 2)” and written in the JSON format is shown as an example. “(Output 3)” is a portion that prompts the large language model LLM to extract setting information from the job script JbSc following “(Input 3)” and to output the extracted setting information. In this manner, the format of the extracted setting information is shown together with the job script JbSc as an example, whereby expected operation can be performed by the large language model LLM.

### Structure Example 1 of Subcomponent 120B

The subcomponent 120B has a function of performing processing using a classifier Clf.

### Structure Example 1 of Classifier Clf

The classifier Clf has a function of determining whether the setting information Cnf1 includes an inappropriate setting and outputting the determination result TRes (see FIG. 3B).

Specifically, in the case where a sufficiently large memory capacity is not ensured in the setting information Cnf1, the determination result TRes indicating that an inappropriate setting is included is output. Alternatively, in the case where the number of CPUs larger than the degree of parallelism of a program is assigned in the setting information Cnf1, the determination result TRes indicating that an inappropriate setting is included is output.

For example, among the job scripts JbSc input to a supercomputer, the job script JbSc in which processing does not progress, does not finish, or ends abnormally and the job script JbSc including a setting that unreasonably occupies a calculational resource are highly likely to include inappropriate settings. In addition, information that pairs the item and the value appearing at a high probability in the setting information Cnf1 extracted from the job script JbSc that is highly likely to include an inappropriate setting is highly likely to be inappropriate. With such an assumption, training data can be collected as follows.

The job script JbSc whose processing does not progress or whose processing is not finished is collected, and the setting information Cnf1 that is highly likely to include an inappropriate setting is extracted. Next, the collected setting information Cnf1 is divided into pieces of information in which the item and the value are paired. Furthermore, for each of the divided pieces of information, the probability of appearing in the setting information Cnf1 that is highly likely to include an inappropriate setting is examined. The information that pairs the item and the value and their probability obtained in this manner can be used to predict the probability of the inappropriate setting.

Thus, for example, it is possible to determine whether the inappropriate setting is included in the job script JbSc input to the supercomputer. For another example, it is possible to determine whether the setting that unreasonably occupies the calculational resource prepared for parallel processing is included in the job script JbSc. For another example, when a setting of a calculation end time is not included in the setting information Cnf1, it is possible to determine that the job script JbSc includes an inappropriate setting. For another example, the user of the data processing system can be provided with the determination result TRes. For another example, the user of the data processing system can review the job script JbSc. As a result, a novel data processing system that is highly convenient, useful, or reliable can be provided.

### Structure Example 2 of Component 130

The component 130 has a function of receiving a prompt Pt2.

### Structure Example 2 of Large Language Model LLM

The large language model LLM has a function of converting the setting information Cnf1 into setting information Cnf2 in accordance with the prompt Pt2.

### Structure Example of Setting Information Cnf2

The setting information Cnf2 includes one or more fixed expressions FEx. For example, information that pairs the item and the value included in the setting information Cnf1 can be converted into one fixed expression FEx. Thus, one fixed expression FEx can serve as the information that pairs the item and the value. For another example, the information that pairs the item and the value included in the setting information Cnf1 can be divided into a plurality of fixed expressions FEx. Thus, a plurality of pieces of information included in one item can be separated from each other.

Specifically, “number of GPUs”:4, which is information that pairs the item and the value, can be converted into a fixed expression “number of GPUs:4”. Furthermore, “job-name”: “CAD_LLM-8B”, which is information that pairs the item and the value, can be separated into a fixed expression “CAD” and a fixed expression “LLM-8B”.

Thus, the probability that the setting information Cnf2 is inappropriate can be predicted from the appearance probability of the fixed expression FEx.

### Structure Example 2 of Component 120

The component 120 has a function of receiving the setting information Cnf2 and sharing the setting information Cnf2 in the component 120.

### Structure Example 2 of Subcomponent 120A

The subcomponent 120A has a function of creating the prompt Pt2 and transmitting the prompt Pt2 to the component 130.

### Structure Example of Prompt Pt2

The prompt Pt2 includes the setting information Cnf1, a conversion rule CnvR, and an instruction g2( ) (see FIG. 4B).

The conversion rule CnvR includes the fixed expression FEx. For example, an expression that is commonly used by the user of the data processing system can be used as the fixed expression FEx. In the case where the value of a pair of the item and the value is expressed only by a numerical value or a predetermined word, the item and the value are combined as a character string to be used as the fixed expression FEx. For example, “pbs-cpu”: 2 is converted into “pbs-cpu:2” and “queue”: “small” is converted into “queue:small”. In the case where the user can freely write a character string to the value of a pair of the item and the value, the value is expressed as it is or divided into a plurality of character strings and expressed as the fixed expression FEx. For example, “job-name”: “CAD_LLM-8B” is converted into “CAD”,“Llama3-LLM-8B”. In addition, a fluctuation in synonyms or expressions can be consolidated in the fixed expression FEx. Note that one fixed expression is preferably one token. One token is a unit of a character string and has one meaning.

Furthermore, the instruction g2( ) includes an instruction for converting the setting information Cnf1 into the setting information Cnf2 by referring to the conversion rule CnvR and adjusting an expression of the setting information Cnf1 to the fixed expression FEx. For example, the text in the next paragraph can be used as the prompt Pt2.

“Extract information from (Input 2) and output to (Output 2) in similar way that (Output 1) is extracted from (Input 1).
(Input 1)
[
   “job-name”: “CAD_LLM-8B”,
   “queue”: “small”,
   “pbs-cpu”: 2,
   “pbs-gpu”: 1,
   “pbs-mem”: 40,
   “real-cpu”: 8,
   “real-gpu”: 4
}
(Output 1)
[
   “CAD”,
   “Llama3-LLM-8B”,
   “queue:small”,
   “pbs-cpu:2”,
   “pbs-gpu:1”,
   “pbs-mem:40”,
   “real-cpu:8”,
   “real-gpu:4”
]
(Input 2)
{
   “job-name”: “EDA_LLM-8B-Instruct”,
   “queue”: “large”,
   “pbs-cpu”: 4,
   “pbs-gpu”: 3,
   “pbs-mem”: 80,
   “real-cpu”: 1,
   “real-gpu”: 2
}
(Output 2)
”

Note that the above text “Extract information from (Input 2) and output to (Output 2) in similar way that (Output 1) is extracted from (Input 1).” corresponds to the instruction g2( ). “(Input 1)” and “(Input 2)” are headings, and portions following the headings each correspond to the setting information Cnf1. “(Output 1)” is a heading, and a portion following the heading corresponds to a conversion rule for converting the setting information Cnf1 that immediately follows “(Output 1)” into the setting information Cnf2. Note that this example shows a conversion rule for converting information that pairs the item and the value into one token. The last “(Output 2)” is a portion that prompts the large language model LLM to convert the setting information Cnf1 that immediately follows “(Input 2)”.

### Structure Example 2 of Subcomponent 120B

The subcomponent 120B has a function of performing processing using a simple Bayesian model NBM. Note that an open source programming language Python is provided with “scikit-learn”, which is a library for machine learning. For example, a simple Bayesian model included in the “scikit-learn” can be used as the simple Bayesian model NBM.

### Structure Example of Simple Bayesian Model NBM

The simple Bayesian model NBM has a function of estimating the probability that the setting information Cnf2 includes an inappropriate setting. Note that probability P (B|A), which is collected in advance, that an inappropriate setting includes the fixed expression FEx, probability P(A) that the job script JbSc including an inappropriate setting is input, and probability P(B) that the input job script JbSc includes the fixed expression FEx can be used for the training data.

### Structure Example 2 of Classifier Clf

The classifier Clf is a data processing system that uses the estimation result of the simple Bayesian model NBM to determine whether the setting information Cnf1 includes an inappropriate setting.

Thus, the same or similar expressions used in the setting information Cnf1 can be consolidated in the fixed expression FEx. For example, in the case where the setting information Cnf1 includes a fluctuation in expressions, the expressions can be converted into any of the fixed expressions FEx. In addition, probability P(A|B) that the setting information Cnf2 including one fixed expression FEx is inappropriate can be found using the simple Bayesian model NBM. For another example, the probability P(B|A) that an inappropriate setting includes the fixed expression FEx, the probability P(A) that the job script JbSc including an inappropriate setting is input, and the probability P(B) that the job script JbSc that is input includes the fixed expression FEx can be used for the training data. Furthermore, the probability P(A|B) can be predicted from the value obtained by dividing the product of the probability P(B|A) and the probability P(A) by the probability P(B). Moreover, it is possible to accurately determine whether the setting information Cnf1 includes an inappropriate setting using the probability P(A|B). For example, the user of the data processing system can be provided with the determination result TRes. For another example, the user of the data processing system can review the job script JbSc. As a result, a novel data processing system that is highly convenient, useful, or reliable can be provided.

### Structure Example 3 of Component 120

The component 120 includes a subcomponent 120C.

### Structure Example of Subcomponent 120C

The subcomponent 120C has a function of calculating an elapsed time LT since the input of the job script JbSc and a function of adding the elapsed time LT to the setting information Cnf2.

Thus, it is possible to determine whether an inappropriate setting is included in the job script JbSc that has been input to the supercomputer on the basis of the elapsed time LT, for example. Furthermore, on the basis of the elapsed time LT, the user of the data processing system can be prompted to review the job script JbSc, for example. For another example, the user of the data processing system can be provided with the determination result TRes. For another example, the user of the data processing system can review the job script JbSc. As a result, a novel data processing system that is highly convenient, useful, or reliable can be provided.

### Structure Example 2 of Data Processing System

The data processing system described in this embodiment includes a component 140. The component 140 includes, for example, a plurality of calculation nodes and a high-speed network greater than or equal to 10 Gbps connecting the plurality of calculation nodes. Specifically, the component 140 includes several tens of calculation nodes, and in some cases, includes several thousand calculation nodes.

### Structure Example of Component 140

The component 140 has a function of receiving the job script JbSc and transmitting a calculation result Res to the component 120, and a function of receiving a priority change command SchP and changing the priority of the job script JbSc. Note that the calculation result Res is a result of executing the job script JbSc. The calculation result Res indicates the end of the job script JbSc.

### Structure Example 4 of Component 120

The component 120 has a function of transmitting the job script JbSc to the component 140, a function of transmitting the priority change command SchP to the component 140 when the setting information Cnf1 is determined to include an inappropriate setting, and a function of receiving the calculation result Res and transmitting the calculation result Res to the component 110.

### Structure Example 2 of Component 110

The component 110 has a function of receiving and providing the calculation result Res.

Thus, when the execution of the job script JbSc is completed, the user of the data processing system can be provided with the calculation result Res for example. When the job script JbSc has a high possibility of including an inappropriate setting, the priority change command SchP can be transmitted to the component 140. In addition, the execution of the job script JbSc including an inappropriate setting can be delayed using the priority change command SchP. As a result, a novel data processing system that is highly convenient, useful, or reliable can be provided.

### Structure Example 3 of Data Processing System

The data processing system described in this embodiment includes the component 110, the component 120, the component 130, and the component 140 (see FIG. 1).

The data processing system of one embodiment of the present invention can be composed of a data processing device having a function of the component 110, a data processing device having a function of the component 120, a data processing device having a function of the component 130, and a data processing device having a function of the component 140, for example. Note that the number of data processing devices constituting the data processing system of one embodiment of the present invention is one or more. For example, a plurality of data processing devices can be connected to each other using a network 51 to construct the data processing system of one embodiment of the present invention.

When the data processing system of one embodiment of the present invention is constituted with the plurality of data processing devices, loads relating to data processing can be dispersed.

### Structure Example 1 of Data Processing Device

A structure example 1 of the data processing device described in this embodiment can be used as the component 110. The structure example 1 of the data processing device can be referred to as a client computer or the like. For example, a desktop computer can be used as the component 110.

The structure example 1 of the data processing device can receive data input by the user of the data processing system of one embodiment of the present invention. The structure example 1 of the data processing device can provide data output from the data processing system of one embodiment of the present invention to the user.

In the component 110, for example, dedicated application software or a web browser operates. Via either of them, the user of the data processing system of one embodiment of the present invention can access the data processing system. Thus, the user can receive service using the data processing system of one embodiment of the present invention.

### Structure Example 2 of Data Processing Device

A structure example 2 of the data processing device described in this embodiment can be used as each of the component 120 and the component 140. For example, a workstation, a server computer, or a supercomputer can be used as each of the component 120 and the component 140.

The structure example 2 of the data processing device preferably has a function of a parallel computer. When the data processing device with the structure example 2 is used as a parallel computer, large-scale computation necessary for artificial intelligence (AI) learning and inference can be performed, for example.

Furthermore, the structure example 2 of the data processing device can perform processing using a natural language model with use of AI.

For example, processing using natural language models (natural language processing) such as GPT-3 (registered trademark), GPT-3.5, GPT-4 (registered trademark), LaMDA, Llama2, Llama3, and Codellama can be performed.

### Structure Example 3 of Data Processing Device

A structure example 3 of the data processing device described in this embodiment can be used as the component 130, for example. Note that the component 130 has a larger scale and higher computational capability than the component 120. For example, a large computer such as a server computer or a supercomputer can be used as the component 130.

The structure example 3 of the data processing device preferably has a function of a parallel computer. When the data processing device with the structure example 3 is used as a parallel computer, large-scale computation necessary for AI learning and inference can be performed, for example.

Furthermore, the structure example 3 of the data processing device can perform processing using a natural language model with use of AI. In particular, the structure example 3 of the data processing device can execute processing using a general-purpose language processing model capable of performing a variety of natural language processing tasks.

For example, the structure example 3 of the data processing device can perform processing using a natural language model such as GPT-3 (registered trademark), GPT-3.5, GPT-4 (registered trademark), LaMDA, Llama2, Llama3, or Codellama. In particular, the structure example 3 of the data processing device is preferably capable of performing processing using GPT-4 (registered trademark). For example, processing using a language model that is larger in scale than a conventional natural language model can achieve more natural text generation, interaction, or the like.

Note that a service provider using the data processing system of one embodiment of the present invention does not necessarily have its own structure example 3 of the data processing device. For example, a service provider can utilize part of the service that another company or the like provides using the structure example 3 of the data processing device.

### Structure Example of Network 51

The network 51 that can be used for the data processing system of one embodiment of the present invention can connect the plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using the data processing method of one embodiment of the present invention via the network 51, for example.

Note that in the case where the data processing system of one embodiment of the present invention is constructed in a local network, the possibility of leakage of confidential information can be lower than that in the case of using the Internet, for example.

### Structure Example 4 of Data Processing Device

A data processing device 20 that can be used for the data processing system of one embodiment of the present invention includes, for example, an input unit 21, a storage unit 22, a processing unit 23, an output unit 24, and a transmission path 25 (see FIG. 6).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed by the processing unit 23 may be executed in different data processing devices depending on processing content.

### Input Unit 21

The input unit 21 can receive data from the outside of the data processing device. For example, the input unit 21 receives data via the network 51.

The input unit 21 supplies the received data to one or both of the storage unit 22 and the processing unit 23 via the transmission path 25.

### Storage Unit 22

The storage unit 22 has a function of storing a program to be performed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The data processing device can include a database in addition to the storage unit 22. The data processing device can have a function of extracting data from a database outside the storage unit 22, the data processing device, or the data processing system. Alternatively, the data processing device can have a function of extracting data from both of its own database and an external database.

One or both of a storage and a file server can be used as the storage unit 22. In addition, a database in which a path of a file held in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a recording media drive. Examples of the recording media drive include a hard disk drive (HDD) and a solid state drive (SSD).

Note that “NOSRAM” is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, a NOSRAM is capable of reading retained data without destruction (non-destructive reading), and thus is suitable for arithmetic processing in which only data reading operations are repeated many times. A NOSRAM can have large data capacity when stacked in layers, and thus, a semiconductor device in which a NOSRAM is used for a large-scale cache memory, a large-scale main memory, or a large-scale storage memory can have higher performance.

“DOSRAM” is an abbreviation for “dynamic oxide semiconductor RAM” and refers to a RAM including a one-transistor (1T) and one-capacitor (1C) memory cell. A DOSRAM is a DRAM formed using an OS transistor and temporarily stores information transmitted from the outside. A DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### Processing Unit 23

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of recording or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. With a processor, the processing unit 23 can interpret and execute commands from various kinds of programs to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with use of the OS transistor as a switch for retaining electric charge (data) that has flowed into a capacitor functioning as a storage element. When at least one of a register and a cache memory included in the processing unit has such a feature, the processing unit can be operated only when needed, and otherwise can be off while data processed immediately before turning off the processing unit is stored in the storage element. In other words, normally-off computing is possible and the power consumption of the data processing system can be reduced.

The data processing device preferably uses AI for at least part of its processing.

In particular, the data processing device preferably uses an artificial neural network (ANN; hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### Output Unit 24

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used for the output unit 24. Furthermore, a device having a communication function may be used as the input unit 21 and the output unit 24.

### Transmission Path 25

The transmission path 25 has a function of transmitting data. Data transmission and reception between the input unit 21, the storage unit 22, the processing unit 23, and the output unit 24 can be performed via the transmission path 25. Specifically, an external bus, a LAN or the Internet can be used for the transmission path 25.

Note that this embodiment can be combined with any of the other embodiments in this specification as appropriate.

### Embodiment 2

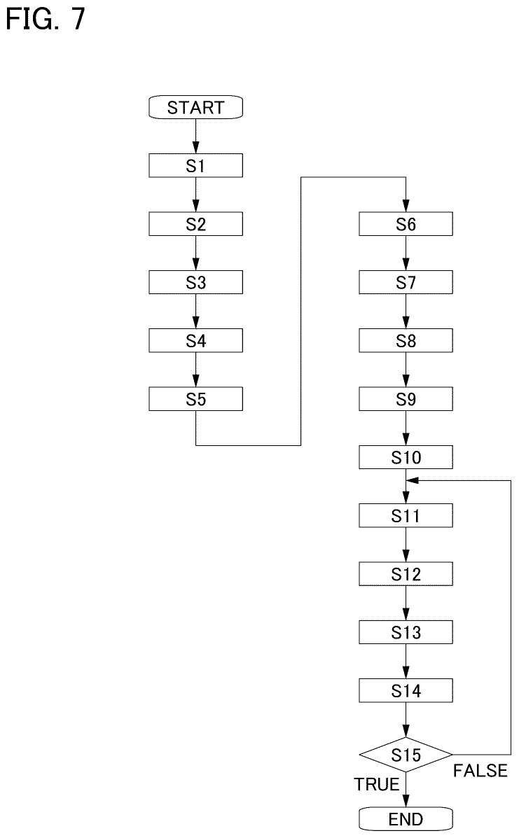

In this embodiment, a data processing method of one embodiment of the present invention will be described with reference to FIG. 7.

FIG. 7 is a flow chart showing a data processing method of one embodiment of the present invention.

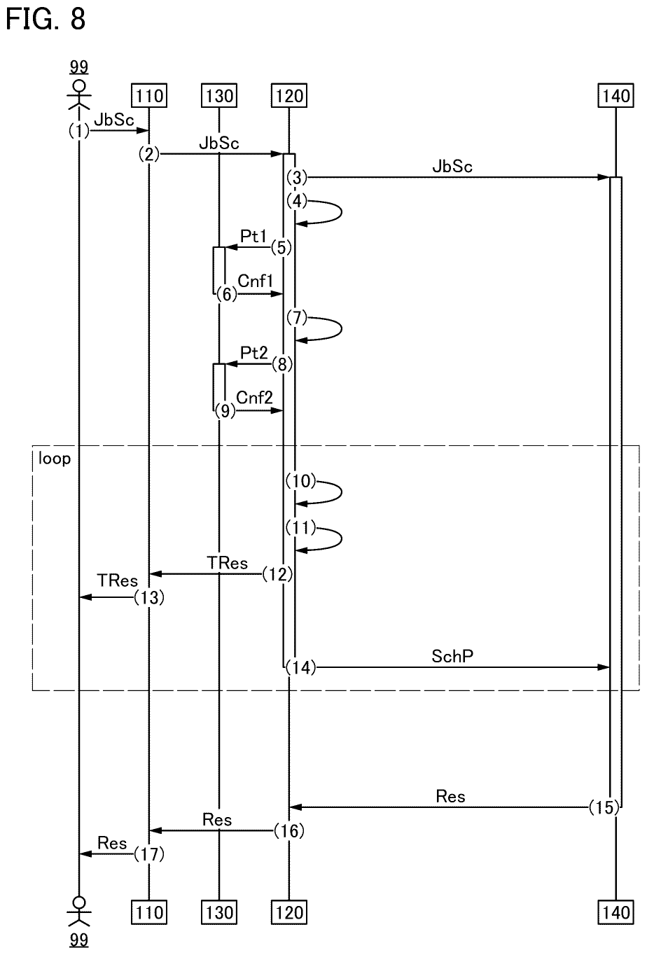

FIG. 8 is a sequence diagram showing a data processing method of one embodiment of the present invention.

### Example 1 of Data Processing Method

The data processing method of one embodiment of the present invention includes Steps S1 to S15 (see FIG. 7).

### Step S1

In Step S1, the component 110 receives the job script JbSc and transmits the job script JbSc to the component 120. For example, the user 99 of the data processing system inputs the job script JbSc to the component 110. Note that in FIG. 8, Step S1 corresponds to an arrow extending from (1) and an arrow extending from (2).

### Step S2

In Step S2, the component 120 receives the job script JbSc and shares the job script JbSc in the component 120. Note that the job script JbSc includes the setting information Cnf1. The component 120 includes the subcomponent 120A and the subcomponent 120B.

### Step S3

In Step S3, the subcomponent 120A creates the prompt Pt1 and transmits the prompt Pt1 to the component 130. Note that the prompt Pt1 includes the job script JbSc and the instruction g1( ). The instruction g1( ) includes an instruction for extracting the setting information Cnf1 from the job script JbSc. Note that in FIG. 8, Step S3 corresponds to an arrow extending from (4) and an arrow extending from (5).

### Step S4

In Step S4, the component 130 receives the prompt Pt1 and extracts the setting information Cnf1 using the large language model LLM.

### Step S5

In Step S5, the component 130 transmits the setting information Cnf1 to the component 120. Note that in FIG. 8, Step S5 corresponds to an arrow extending from (6).

### Step S6

In Step S6, the component 120 receives the setting information Cnf1 and shares the setting information Cnf1 in the component 120.

### Step S7

In Step S7, the subcomponent 120A creates the prompt Pt2 and transmits the prompt Pt2 to the component 130. Note that the prompt Pt2 includes the setting information Cnf1 and the instruction g2( ). The instruction g2( ) includes an instruction for converting the setting information Cnf1 into the setting information Cnf2 by adjusting an expression of the setting information Cnf1 to the fixed expression FEx. Note that in FIG. 8, Step S7 corresponds to an arrow extending from (7) and an arrow extending from (8).

### Step S8

In Step S8, the component 130 receives the prompt Pt2 and converts the setting information Cnf1 into the setting information Cnf2 using the large language model LLM.

### Step S9

In Step S9, the component 130 transmits the setting information Cnf2 to the component 120. Note that in FIG. 8, Step S9 corresponds to an arrow extending from (9).

### Step S10

In Step S10, the component 120 receives the setting information Cnf2 and shares the setting information Cnf2 in the component 120.

### Step S11

In Step S11, the subcomponent 120B estimates the probability that the setting information Cnf2 includes an inappropriate setting using the simple Bayesian model NBM. Note that in FIG. 8, Step S11 corresponds to an arrow extending from (10).

### Step S12

In Step S12, the classifier Clf determines whether the setting information Cnf1 includes an inappropriate setting using the estimation result of the setting information Cnf2 according to the simple Bayesian model NBM and outputs the determination result TRes. Note that in FIG. 8, Step S12 corresponds to an arrow extending from (11).

### Step S13

In Step S13, the component 120 transmits the determination result TRes to the component 110. Note that in FIG. 8, Step S13 corresponds to an arrow extending from (12).

### Step S14

In Step S14, the component 120 calculates the elapsed time LT since the input of the job script JbSc at a predetermined time, and the elapsed time LT is added to the setting information Cnf2 and shared in the component 120.

### Step S15

In Step S15, whether the job script JbSc is finished is determined; the processing ends in the case where the job script JbSc is finished (TRUE), and the processing proceeds to Step S11 in the case where the job script JbSc is not finished (FALSE). Note that Step S11 to Step S15 each correspond to the loop portion in FIG. 8.

Thus, the same or similar expressions used in the setting information Cnf1 can be consolidated in the fixed expression FEx. For example, in the case where the setting information Cnf1 includes a fluctuation in expressions, the expressions can be converted into any of the fixed expressions FEx. The probability P(A|B) that the setting information Cnf2 including one fixed expression FEx is inappropriate can be found using the simple Bayesian model NBM. For another example, the probability P(B|A) that an inappropriate setting includes the fixed expression FEx, the probability P(A) that the job script JbSc including an inappropriate setting is input, and the probability P(B) that the job script JbSc that is input includes the fixed expression FEx can be used for the training data. The probability P(A|B) can be predicted from the value obtained by dividing the product of the probability P(B|A) and the probability P(A) by the probability P(B). It is possible to accurately determine whether the setting information Cnf1 includes an inappropriate setting using the probability P(A|B). In addition, it is possible to determine whether an inappropriate setting is included in the job script JbSc that has been input to the supercomputer on the basis of the elapsed time LT, for example. On the basis of the elapsed time LT, the user of the data processing system can be prompted to review the job script JbSc, for example. When the job script JbSc has a high possibility of including an inappropriate setting, the user of the data processing system can be provided with the determination result TRes, for example. For another example, the user of the data processing system can review the job script JbSc. As a result, a novel data processing method that is highly convenient, useful, or reliable can be provided.

### Example 2 of Data Processing Method

The data processing method of one embodiment of the present invention includes Steps S1 to S15 (see FIG. 7). Note that the data processing method described in this embodiment is different from the data processing method in Step S2 and Step S13. Here, different parts will be described in detail, and the above description is referred to for similar parts.

### Step S2

In Step S2, the component 120 receives the job script JbSc and transmits the job script JbSc to the component 140. Note that in FIG. 8, Step S2 corresponds to an arrow extending from (3).

The component 140 has a function of receiving the job script JbSc, executing the job, and transmitting the calculation result Res to the component 120. In addition, the component 140 has a function of receiving the priority change command SchP and changing the priority of the job script JbSc. In other words, the component 140 has a function of switching the order of executing the job script JbSc specified by the priority change command SchP and the order of executing another job script JbSc.

### Step S13

When it is determined that the setting information Cnf1 includes an inappropriate setting, the component 120 transmits the priority change command SchP to the component 140 in Step S13. Note that in FIG. 8, Step S13 corresponds to an arrow extending from (14).

Accordingly, when the job script JbSc has a high possibility of including an inappropriate setting, the priority change command SchP can be transmitted to the component 140. In addition, the execution of the job script JbSc including an inappropriate setting can be delayed using the priority change command SchP. As a result, a novel data processing method that is highly convenient, useful, or reliable can be provided.

Note that the component 140 transmits the calculation result Res to the component 120 every time the input job is finished. The component 120 receives the calculation result Res and transmits the calculation result Res to the component 110. The component 110 provides the user 99 of the data processing system with the calculation result Res, for example. Note that in FIG. 8, the above steps correspond to arrows extending from (15), (16), and (17).

Note that this embodiment can be combined with any of the other embodiments in this specification as appropriate.

This application is based on Japanese Patent Application Serial No. 2024-108622 filed with Japan Patent Office on Jul. 5, 2024, the entire contents of which are hereby incorporated by reference.

What is claimed is:

1. A data processing system comprising:
a first component;
a second component; and
a third component,
wherein the first component is configured to receive a job script, to transmit the job script to the third component, to receive a determination result, and to provide the determination result,
wherein the job script comprises first setting information,
wherein the second component is configured to receive a first prompt, to transmit the first setting information to the third component, and to perform processing using a large language model,
wherein the large language model is configured to extract the first setting information from the job script in accordance with the first prompt,
wherein the third component is configured to receive the job script and the first setting information, to share the job script and the first setting information in the third component, and to transmit the determination result to the first component,
wherein the third component comprises a first subcomponent and a second subcomponent,
wherein the first subcomponent is configured to create the first prompt and to transmit the first prompt to the second component,
wherein the first prompt comprises the job script and a first instruction,
wherein the first instruction comprises an instruction for extracting the first setting information from the job script,
wherein the second subcomponent is configured to perform processing using a classifier, and
wherein the classifier is configured to determine whether the first setting information comprises an inappropriate setting and to output the determination result.

2. The data processing system according to claim 1,
wherein the second component is configured to receive a second prompt,
wherein the large language model is configured to convert the first setting information into second setting information in accordance with the second prompt,
wherein the third component is configured to receive the second setting information and to share the second setting information in the third component,
wherein the first subcomponent is configured to create the second prompt and to transmit the second prompt to the second component,
wherein the second prompt comprises the first setting information, a conversion rule, and a second instruction,
wherein the conversion rule comprises a fixed expression,
wherein the second instruction comprises an instruction for converting the first setting information into the second setting information by referring to the conversion rule and adjusting an expression of the first setting information to the fixed expression,
wherein the second subcomponent is configured to perform processing using a simple Bayesian model,
wherein the simple Bayesian model is configured to estimate probability that the second setting information comprises an inappropriate setting, and
wherein the classifier uses an estimation result of the simple Bayesian model to determine whether the first setting information comprises the inappropriate setting.

3. The data processing system according to claim 2,
wherein the third component comprises a third subcomponent, and
wherein the third subcomponent is configured to calculate an elapsed time since input of the job script and to add the elapsed time to the second setting information.

4. The data processing system according to claim 3, further comprising a fourth component,
wherein the fourth component is configured to receive the job script, to transmit a calculation result to the third component, to receive a priority change command, and to change a priority of the job script,
wherein the calculation result is a result of executing the job script,
wherein the third component is configured to transmit the job script to the fourth component, to transmit the priority change command to the fourth component in the case where the first setting information is determined to include the inappropriate setting, and to receive the calculation result and to transmit the calculation result to the first component, and
wherein the first component is configured to receive the calculation result and to provide the calculation result.

5. A data processing method comprising a first step, a second step, a third step, a fourth step, a fifth step, a sixth step, a seventh step, an eighth step, a ninth step, a tenth step, an eleventh step, a twelfth step, a thirteenth step, a fourteenth step, and a fifteenth step,
wherein in the first step, a first component receives a job script and transmits the job script to a second component,
wherein in the second step, the second component receives the job script and shares the job script in the second component,
wherein the job script comprises first setting information,
wherein the second component comprises a first subcomponent and a second subcomponent,
wherein in the third step, the first subcomponent creates a first prompt and transmits the first prompt to a third component,
wherein the first prompt comprises the job script and a first instruction,
wherein the first instruction comprises an instruction for extracting the first setting information from the job script,
wherein in the fourth step, the third component receives the first prompt and extracts the first setting information using a large language model,
wherein in the fifth step, the third component transmits the first setting information to the second component,
wherein in the sixth step, the second component receives the first setting information and shares the first setting information in the second component,
wherein in the seventh step, the first subcomponent creates a second prompt and transmits the second prompt to the third component,
wherein the second prompt comprises the first setting information and a second instruction,
wherein the second instruction comprises an instruction for converting the first setting information into second setting information by adjusting an expression of the first setting information to a fixed expression,
wherein in the eighth step, the third component receives the second prompt and converts the first setting information into the second setting information using the large language model,
wherein in the ninth step, the third component transmits the second setting information to the second component,
wherein in the tenth step, the second component receives the second setting information and shares the second setting information in the second component,
wherein in the eleventh step, the second subcomponent estimates probability that the second setting information comprises an inappropriate setting using a simple Bayesian model,
wherein in the twelfth step, a classifier determines whether the first setting information comprises an inappropriate setting using an estimation result of the second setting information of the simple Bayesian model and outputs a determination result,
wherein in the thirteenth step, the second component transmits the determination result to the first component,
wherein in the fourteenth step, the second component calculates an elapsed time since input of the job script at a predetermined time, and the elapsed time is added to the second setting information and shared in the second component, and
wherein in the fifteenth step, processing ends in the case where the job script is finished, and the processing proceeds to the eleventh step in the case where the job script is not finished.

6. The data processing method according to claim 5,
wherein in the second step, the second component receives the job script and transmits the job script to a fourth component,
wherein the fourth component is configured to receive the job script, to transmit a calculation result to the second component, to receive a priority change command, and to change a priority of the job script, and
wherein in the case where the first setting information is determined to include the inappropriate setting, the second component transmits the priority change command to the fourth component in the thirteenth step.
